(19) United States
(12) Patent Application Publication
(10) Pub. No.: US 2014/0103057 A1
(43) Pub. Date: Apr. 17, 2014

(54) PACKET DISPENSER

(71) Applicant: MonoSol Rx, LLC, Warren, NJ (US)

(72) Inventors: Richard C. Fuisz, Beverly Hills, CA (US); Bruce D. Detwiler, Boyertown, PA (US); Garry L. Myers, Kingsport, TN (US); Pradeep Sanghvi, Dyer, IN (US); Madhusudan Hariharan, Munster, IN (US); Laura Moss, Schererville, IN (US)

(73) Assignee: MonoSol Rx, LLC, Warren, NJ (US)

(21) Appl. No.: 14/133,498

(22) Filed: Dec. 18, 2013

Related U.S. Application Data
(63) Continuation of application No. 11/824,153, filed on Jun. 29, 2007.
(60) Provisional application No. 60/917,941, filed on May 15, 2007.

(51) Int. Cl. G07F 11/04

(52) U.S. Cl. CPC G07F 11/045
USPC 221/30

(57) ABSTRACT

The packet dispenser includes a container structure having an interior cavity. The cavity has a sufficient dimension such that a packet structure may be stored therein. The container structure has an opening to the cavity through which the packet structure can be removed therefrom. A tear structure is connected to the container structure such that the packet structure may contact the tear structure to tear a portion thereof when the packet structure is removed from the cavity.

### CROSS-REFERENCE TO RELATED APPLICATION

This patent application claims priority to and the benefit of U.S. Provisional Patent Application No. 60/817,941 filed on Jun. 30, 2006, which is incorporated by reference herein.

### FIELD OF THE INVENTION

The present invention relates generally to a packet dispenser and, more specifically, to a packet dispenser in which are stored packets which contain strips, such as strips which are pharmaceutical-impregnated and digestible. The packet dispenser provides for tearing of the packets upon removal thereof from the packet dispenser.

### BACKGROUND OF THE INVENTION

Pharmaceuticals and similar substances are typically required to be ingested in relatively precise amounts. One technique for providing pharmaceuticals in such relatively precise amounts for ingestion is to impregnate a digestible strip with the relatively precise amount of the pharmaceutical. The user may then place the strip in their mouth and receive the relatively precise amount of the pharmaceutical.

Such impregnated strips may be contained within a packet for storage before ingestion by the user. Such packets provide protection to the strip and maintain the pharmaceutical in a controlled environment before ingestion thereof by the user. The packets are typically opened by the user manually tearing the packet to gain access to the strip therein.

Preferably, the packets are difficult for a child to open which provides the packets with child-resistance. Providing the packets with this feature reduces the likelihood of children gaining access to the strips within the packets. Frequently, the pharmaceuticals or other substances of which the strips are impregnated are preferably not accessible directly by children. This is a consequence of the proper use of such pharmaceuticals or other substances normally being beyond the capabilities of children.

The desirability of making the packets child resistant may result in the packets being difficult to open by an adult. For example, the packets may be made child-resistant by using a strong material which provides considerable resistance to the manual tearing thereof which is typically required to gain access to the strip within the packet. The resistance to manual tearing of the packets may be sufficient to provide excessive resistance to adults who attempt to open the packets. However, adults typically need to be able to open the packets. Consequently, the configuration and fabrication of the packets may be difficult.

### SUMMARY OF THE INVENTION

The packet dispenser of the present invention includes a container structure having an interior cavity. The cavity has a sufficient dimension such that a packet structure may be stored therein. The container structure has an opening to the cavity through which the packet structure can be removed therefrom. A tear structure is connected to the container structure such that the packet structure may contact the tear structure to tear a portion thereof when the packet structure is removed from the cavity.

The tear structure facilitates manual tearing of a packet structure which is otherwise difficult to manually tear. Consequently, the packet structure may be sufficiently difficult to open by a child to satisfy the requirements of child-resistance. Also, the tear structure may be configured to be difficult to operate by a child to further provide child-resistance. However, the tear structure may be configured to be readily operable by an adult to tear a portion of the packet structure. The tearing provides a site on the packet structure for the initiation of the manual tearing thereof. The manual tearing is thereby facilitated as compared to having to initiate the manual tearing of a packet structure which is intact. Manual tearing of the packet structure provides access to the strip contained therein. Accordingly, the packet dispenser provides child-resistance while allowing adults to open the packet structure.

These and other features of the invention will be more fully understood from the following description of specific embodiments of the invention taken together with the accompanying drawings.

### BRIEF DESCRIPTION OF THE DRAWINGS

In the drawings:

FIG. 1 is a perspective view of the packet dispenser of the present invention, the packet dispenser being shown as having a container structure in which are stored packet structures which contain strip structures;

FIG. 2 is a side elevation view of the packet dispenser of FIG. 1, the container structure being shown as having an opening for removal of the packet structures within the container structure;

FIG. 3 is a transverse cross sectional view in the plane indicated by line 3-3 of FIG. 2 of the packet dispenser and packet structures located within the container structure, the packet dispenser being shown as having a post structure extending through the holes in the packet structures;

FIG. 4 is a top plan view of the bottom structure of the container structure of FIG. 1, the bottom structure being shown as having the top structure removed therefrom, the packet structures being shown as located on the bottom structure such that the post structure extends through the holes in the packet structures;

FIG. 5 is a front view of one of the packet structures located in the container structure of FIG. 1, the packet structure being shown as having outer and inner tear notches which intersect the hole;

FIG. 6 is a perspective view of the packet dispenser of FIG. 1 showing one of the packet structures at two different positions during removal thereof from the container structure, the packet structure being shown as pivoted relative to the container structure;

FIG. 7 is a perspective view of an alternative embodiment of the packet dispenser of FIG. 1, the packet dispenser being shown as having a container structure in which are stored packet structures which contain strip structures, the packet dispenser being shown as having a knife structure which can be depressed;

FIG. 8 is a side elevation view of the packet dispenser of FIG. 7, the container structure being shown as having an opening for removal of the packet structures within the container structure;

FIG. 9 is a transverse cross sectional view in the plane indicated by line 9-9 of FIG. 8 of the packet dispenser and packet structures located within the container structure, the knife structure being shown in the depressed position for engagement with the packet structures upon removal therefrom from the container structure;

FIG. 10 is a top plan view of the top structure of the container structure of FIG. 7, the top structure being shown as pivoted about the right side edge thereof and separated from the bottom structure to show the blade structure; and

FIG. 11 is a perspective view of the packet dispenser of FIG. 7 showing one of the packet structures at two different positions during removal thereof from the container assembly with the knife structure being in the depressed position.

Corresponding reference characters indicate corresponding parts throughout the several views of the drawings.

### DETAILED DESCRIPTION OF THE INVENTION

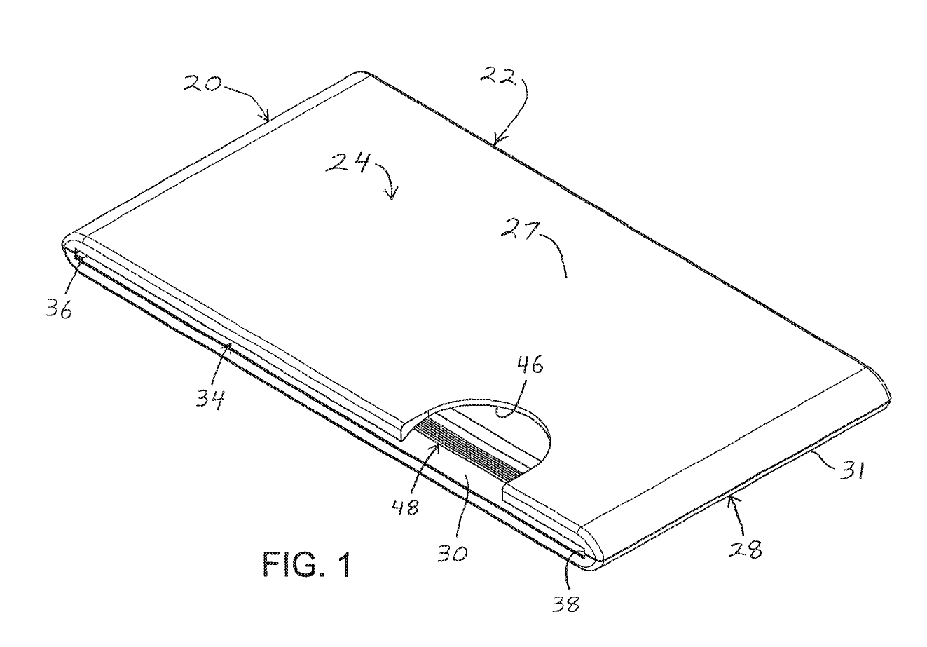

Referring to the drawings and more specifically to FIG. 1, the packet dispenser 20 includes a container structure 22 having a top structure 24 which has an inner surface 26 and an outer surface 27. The container structure 22 has a bottom structure 28 which has an inner surface 30 and an outer surface 31. The top and bottom structures 24, 28 are attached to one another such that the inner surfaces 26, 30 define an interior cavity 32 of the container structure 22. The container structure 22 has an elongate opening 34 to the cavity 32. The opening 34 has a first end 36 and a second end 38.

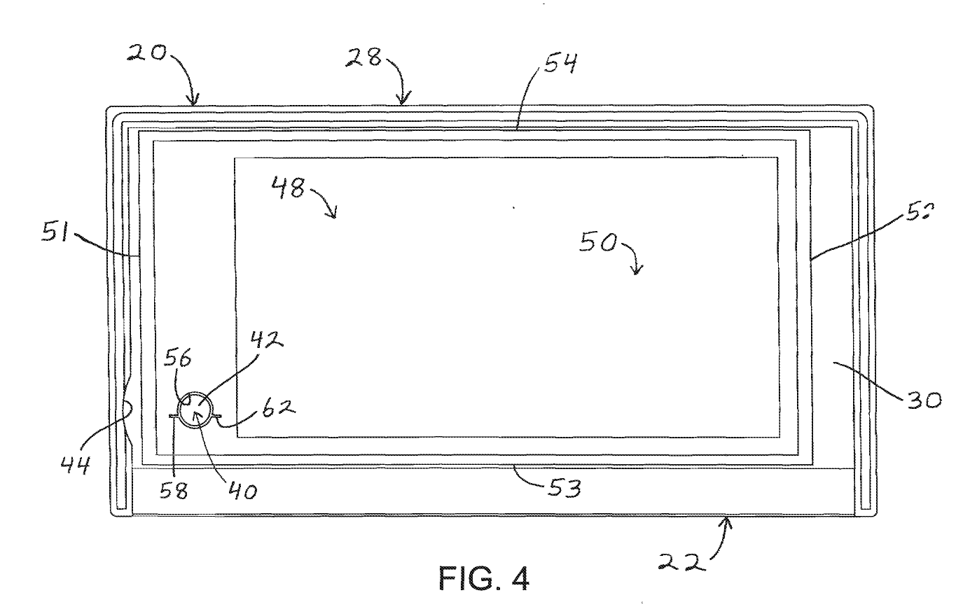

The packet dispenser 20 has a tear structure 40 which is defined by a post structure 42. The post structure 42 is connected to the inner surface 30 of the bottom structure 28, as shown in FIG. 3. The connection between the post structure 42 and the bottom structure 28 may be an integral connection, as shown in FIG. 3. Alternative embodiments of the connection between the post structure 42 and inner surface 26 are possible, such as by an adhesive. The post structure 42 is located adjacent to the opening 34, and is closer to the first end 36 relative to the second end 38. The container structure 22 has an arcuate recess 44 which faces the post structure 42, as shown in FIG. 4.

The container structure 22 has a U-shaped cutout 46 in the top structure 24. The cutout 46 intersects the opening 34 and is closer to the second end 38 relative to the first end 36, as shown in FIG. 1.

The packet dispenser 20 is included in a kit which includes one or more packet structures 48. Each of the packet structures 48 includes an envelope structure 50 which has a cavity, and a strip structure which is contained therein. Each of the envelope structures 50 has opposing side layers between which the cavity of the envelope structure is located. Each of the envelope structures 50 has transverse side edges 51, 52 and longitudinal side edges 53, 54.

The packet structure 48 has a hole 56 which has a center 57. The hole 56 extends through both layers of the envelope structure 50 and through the strip structure which is within the envelope structure. The packet structure 48 has a first tear notch 58 in both layers of the envelope structure 50 and in the strip structure contained therein. The first tear notch 58 is located between the hole 56 and the side edge 51. The first tear notch 58 has a longitudinal central axis, and is oriented relative to the hole 56 such that the longitudinal central axis of the first tear notch is offset from the center 57.

The packet structure 48 has a second tear notch 62 in both layers of the envelope structure 50 and in the strip structure which is within the envelope structure. The second tear notch 62 is located between the hole 56 and side edge 52. The second tear notch 62 has a longitudinal central axis, and is oriented relative to the hole 56 such that the longitudinal central axis of the second tear notch is offset from the center 57. The second tear notch 62 is oriented relative to the first tear notch 58 such that the longitudinal central axes thereof are co-axial. The location of the first and second tear notches 58, 62 relative to the side edges 51, 52 provide for the first tear notch to be an outer tear notch 58 relative to the second tear notch. Additionally, the location of the first and second tear notches 58, 62 relative to the side edges 51, 52 provide for the second tear notch to be an inner tear notch 62 relative to the outer tear notch 58.

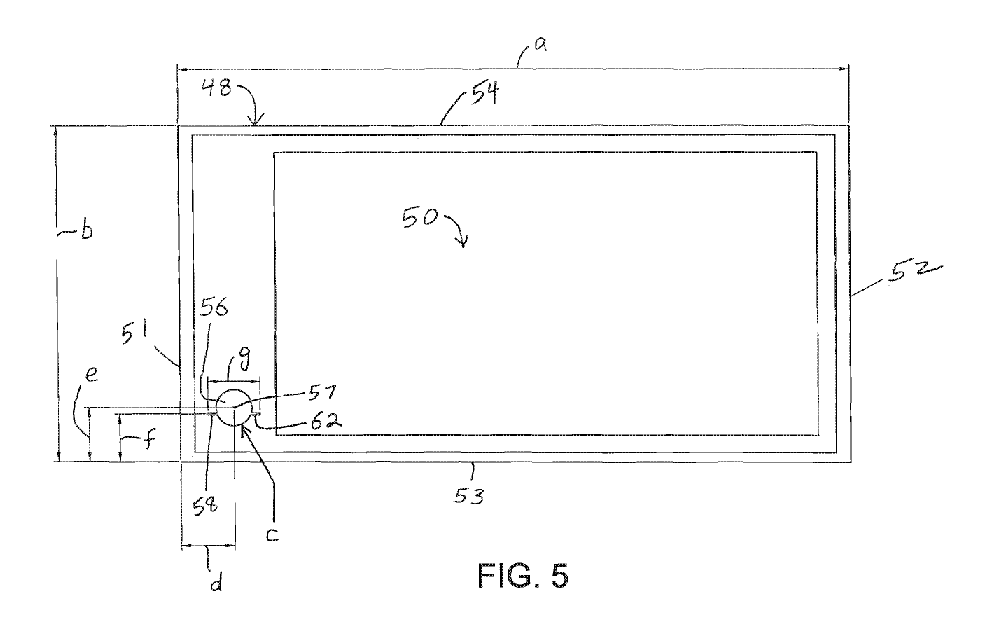

A preferred embodiment of the packet structure 48, including the dimensions thereof, is shown in FIG. 5. The dimensions of the packet structure 48 include:

a—3.5000 in. (inches)

b—1.7500 in.

c—R0.0938 in.

d—0.2813 in.

e—0.2813 in.

f—0.2500 in.

g—0.2724 in.

The cavity 32 has a sufficient dimension to provide for the storage of one or more of the packet structures 48 therein. The one or more packet structures 48 are stored in the cavity 32 such that the post structure 42 extends through the one or more holes 56, as shown in FIG. 4.

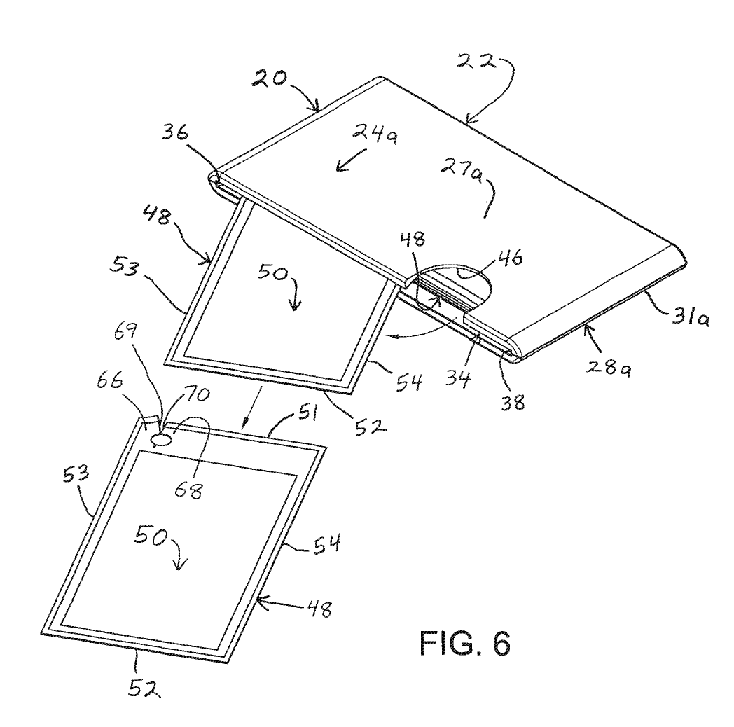

The packet dispenser 20 is operated according to a method which provides for the grasping of the portion of the packet structure 48 which is accessible through the cutout 46. The grasping may be provided by the thumb or a finger of the hand of the user contacting the portion of the packet structure 48 in the cavity 32 of the container structure 22 which is accessible by the cutout 46. The grasping is sufficient to provide frictional contact between the user and packet structure 48 to enable the packet structure to be pivoted relative to the post structure 42. The pivoting is in an angular direction relative to the container structure 22 to provide for a portion of the packet structure 48 to extend out of the cavity 32 through the opening 34, as shown in FIG. 6. The pivoting of the packet structure 48 results in the corner thereof which is adjacent to the hole 56 entering the arcuate recess 44.

The container structure 22 is grasped by one of the hands of the user. More specifically, the container structure 22 may be grasped by the thumb of the hand of the user contacting one of the outer surfaces 27, 31 and the fingers of this hand contacting the other of the outer surfaces 27, 31. The thumb and fingers of this hand are forced together against the outer surfaces 27, 31 to grasp the container structure 22. The portion of the packet structure 48 which extends out of the cavity 32 of the container structure 22 is grasped by the other hand of the user, typically between the thumb and fingers thereof.

The hands of the user are pulled away from one another such that the packet structure 48 is displaced relative to the packet dispenser 20 such that the envelope structure 50 contacts the tear structure 40 which is defined by the post structure 42. The packet structure 48 is pulled away from the post structure 42 with sufficient force such that the envelope structure tears away from the post structure.

The packet structure 48 is pulled in a direction relative to the container structure 22 such that the direction is parallel to the outer tear notch 58. Consequently, the section of the envelope structure 50 which is torn coincides with the outer tear notch 58. This coinciding orientation directs the tearing of the envelope structure 50, which results from the pulling of the packet structure 48 away from the post structure 42, in a preferred direction which coincides with the outer tear notch 58. The complete removal of the packet structure 48 from the cavity 32 results in the entire outer tear notch 58 being torn, as shown in FIG. 6.

The tearing of the envelope structure 50 coinciding with the outer tear notch 58 is provided by the outer tear notch being located in the envelope structure such that the post structure 42 is located between the outer tear notch and section of the packet structure 48 which is pulled for the tearing of the envelope structure from the post structure. Also, the tearing of the envelope structure 50 coinciding with the outer tear notch 58 is provided by the outer tear notch being parallel to the direction in which the packet structure 48 is pulled for the tearing of the envelope structure 50 from the post structure 42.

The pulling of the packet structure 48 from the container structure 22 provides for the complete removal of the packet structure from the cavity 32 which, in turn, provides for the complete tearing of the envelope structure 50 from the post structure 42. The tearing of the envelope structure 50 provides for the formation of a first section 66 and a second section 68 of the envelope structure, as shown in FIG. 6. The first and second sections 66, 68 have corresponding interior edges 69, 70 which intersect the hole 56.

The first section 66 is grasped by one of the hands of the user, such as between the thumb and fingers thereof. The second section 68 is grasped by the other hand of the user, such as between the thumb and fingers thereof. The hands of the user and the respective first and second sections 66, 68 which are grasped therein are displaced relative to one another to displace the first section relative to the second section. The relative displacement of the first and second sections 66, 68 further tears the envelope structure 50 to provide access to the cavity therein.

The section of the envelope structure 50 which is torn by the displacement of the first section 66 relative to the second section 68 coincides with the inner tear notch 62. This coinciding orientation directs the tearing of the envelope structure 50, which results from the displacement of the first section 66 relative to the second section 68, in a preferred direction which coincides with the inner tear notch 62 and intersects the cavity in the envelope structure.

The coinciding of the tearing of the envelope structure 50 with the inner tear notch 62 is provided by the inner tear notch being located between the post structure 42 and the section of the envelope structure which is pulled for the tearing thereof from the post structure. Also, the coinciding of the tearing of the envelope structure 50 with the inner tear notch 62 is provided by the inner tear notch being parallel to the direction in which the envelope structure is pulled for the tearing thereof from the post structure 42.

After the completion of the tearing of the envelope structure 50 by the displacement of the first section 66 relative to the second section 68, access to the strip structure in the cavity in the envelope structure is obtained, such as by separating transversely the opposing surfaces thereof. Subsequently, the strip structure is removed from the cavity in the envelope structure 50.

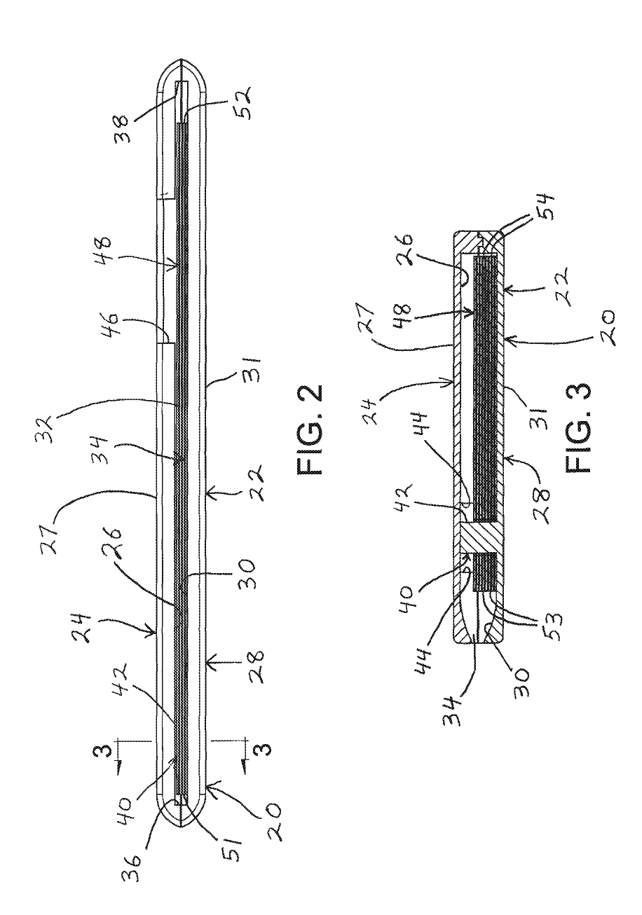

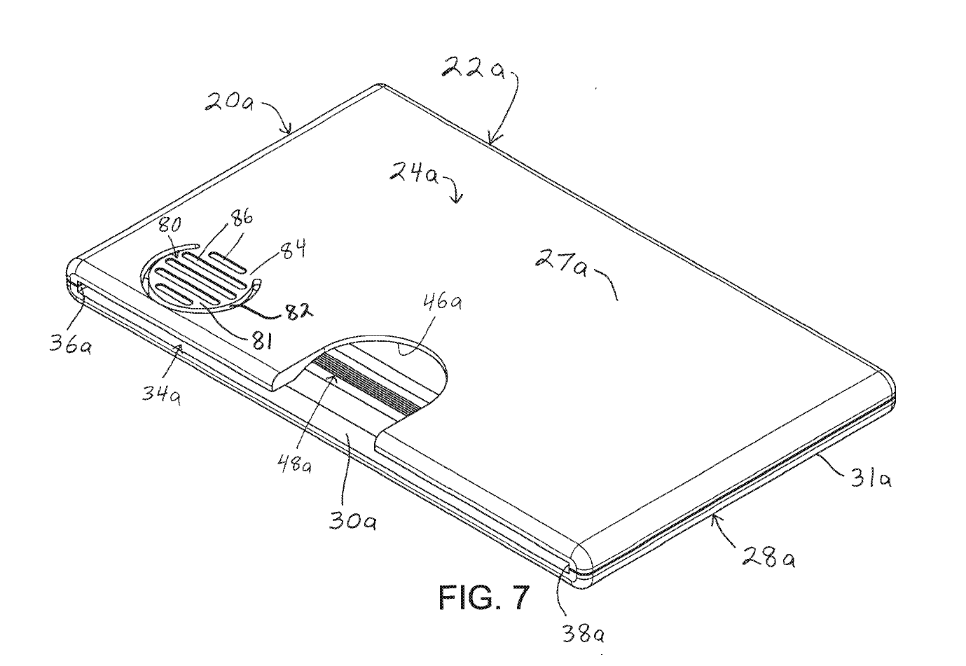

An alternative embodiment of the packet dispenser 20a is shown in FIG. 7. Parts illustrated in FIG. 7 which correspond to parts illustrated in FIGS. 1 to 6 have, in FIG. 7, the same reference numeral as in FIGS. 1 to 6 with the addition of the suffix “a”. In this alternative embodiment, the packet dispenser 20a includes a container structure 22a having a top structure 24a which has an inner surface 26a and an outer surface 27a. The container structure 22a has a bottom structure 28a which has an inner surface 30a and an outer surface 31a. The top and bottom structures 24a, 28a are attached to one another such that the inner surfaces 26a, 30a define an interior cavity 32a of the container structure 22a. The container structure 22a has an elongate opening 34a to the cavity 32a. The opening 34a has a first end 36a and a second end 38a.

The packet dispenser 20a has a tear structure 40a which is defined by a knife structure 72. The knife structure 72 is connected to the inner surface 26 of the top structure 24, as shown in FIG. 9. The knife structure 72 is located adjacent to the opening 34a, and is closer to the first end 36a relative to the second end 38a.

The knife structure 72 is defined by an elongate blade structure 74 having a base 76 which is connected to the inner surface 26a. The blade structure 74 may be formed of a metallic material and, in alternative embodiments, other materials may be included in the blade structure. The blade structure 74 has a cutting edge 78 which extends from the base 76 and terminates at a pointed end, as shown in FIG. 9. The cutting edge 78 is sharpened. The blade structure 74 is oriented relative to the inner surface 26a such that the cutting edge 78 extends from the inner surface 26a in a direction which is generally perpendicular thereto. The orientation of the blade structure 74 further provides for the cutting edge 78 to face the side edges 53a of the packet structures 48a which are stored in the cavity 32a.

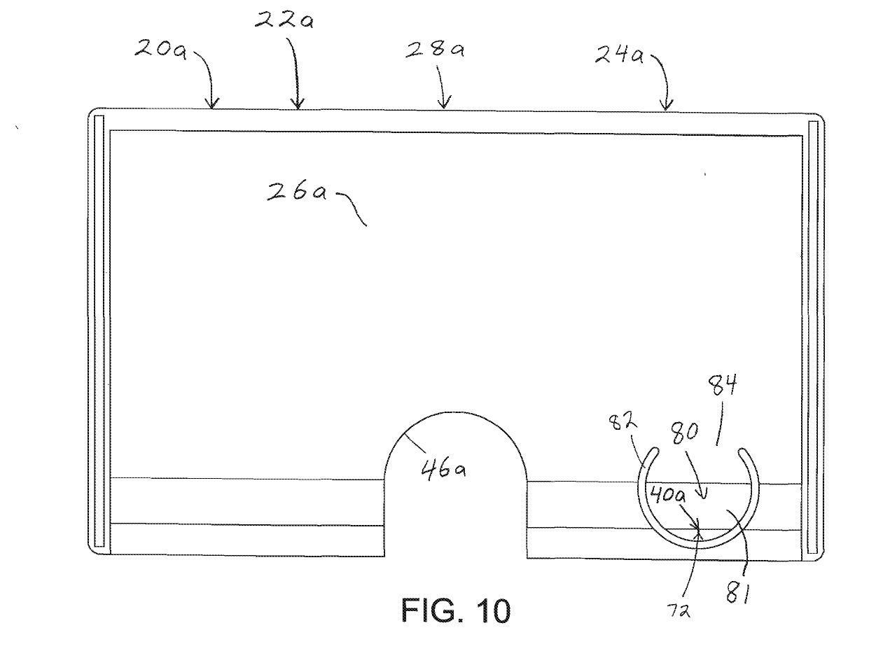

The blade structure 74 is connected to a portion of the top structure 24a which defines a tab structure 80. The tab structure 80 has an outer surface 81. The tab structure 80 has an outer periphery which is defined by a semi-circular gap 82 which extends through the top structure 24a, as shown in FIG. 10. The ends of the gap 82 terminate at the portion of the top structure 24a which defines the hinge structure 84 of the tab structure 80. The hinge structure 84 is located in a portion of the top structure 24a, the material of which is resilient. Consequently, the tab structure 80 may be pivoted relative to the top structure 24a about the hinge structure 84. This provides for the tab structure 80 to be displaced inwardly relative to the top structure 24a when a transverse force which is sufficiently large is applied to the outer surface 81 of the tab structure 80. The transverse force has a direction which is generally perpendicular to the top structure 24a.

The resiliency of the hinge structure 84 forces the tab structure to return to an orientation in which the central plane thereof generally coincides with the central plane of the top structure 24a when the transverse force which is applied to the tab structure 80 is removed therefrom. The tab structure 80 is oriented in a neutral position when the transverse force is removed therefrom. The neutral position of the tab structure 80 is shown in FIG. 9.

The tab structure 80 has a series of elongate recesses 86 which are formed in the outer surface 27a of the top structure 24a, as shown in FIGS. 7 and 9. The recesses 86 have an orientation which is generally parallel to the hinge structure 84.

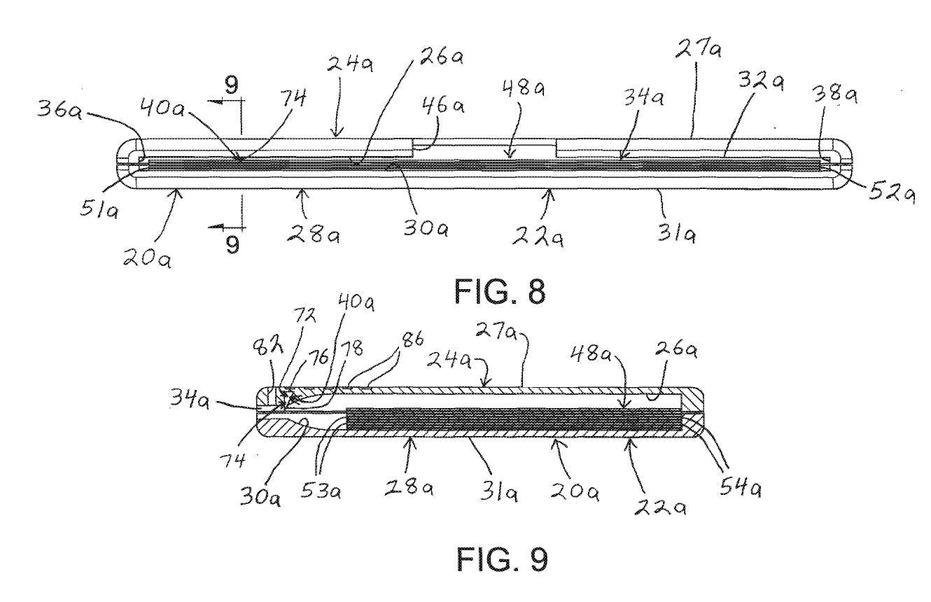

The container structure 22a has a U-shaped cutout 46a in the top structure 24a. The cutout 46a intersects the opening 34a and has generally the same distance from the first and second ends 36a, 38a, as shown in FIGS. 7 and 8.

The packet dispenser 20a is included in a kit which includes one or more packet structures 48a. Each of the packet structures 48a includes an envelope structure 50a which has a cavity, and a strip structure which is contained therein. Each of the envelope structures 50a has opposing side layers between which the cavity of the envelope structure is located. Each of the envelope structures 50a has transverse side edges 51a, 52a, and longitudinal side edges 53a, 54a. The cavity 32a has a sufficient dimension to provide for the storage of one or more of the packet structures 48a therein.

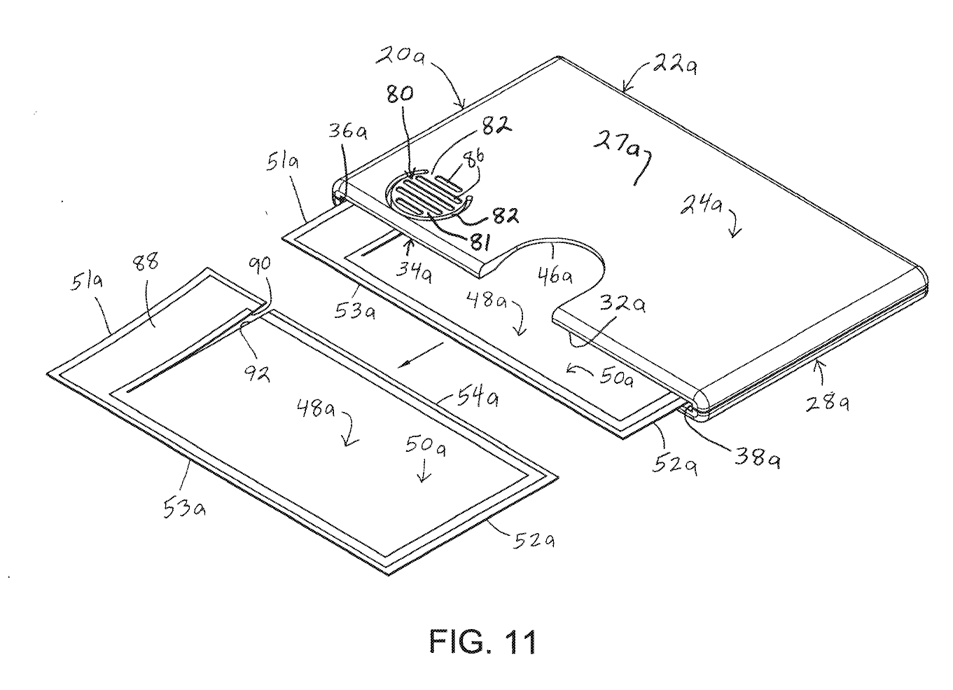

The packet dispenser 20a is operated according to a method which provides for the grasping of the portion of the packet structure 48a which is accessible through the cutout 46a. This portion of the packet structure 48a is grasped by one of the hands of the user, typically between the thumb and fingers thereof. The grasping is sufficient to provide frictional contact between the user and packet structure 48a for the pulling thereof out of the cavity 32a through the opening 34a, as shown in FIG. 11.

When the packet structure 48a is initially pulled through the opening 34a, the knife structure 72 is in the neutral position. The neutral position of the knife structure 72 provides for a clearance between the end 78 of the blade structure 74 and the packet structure 48a. Consequently, the blade structure 74 does not contact the packet structure 48a during the initial pulling thereof through the opening 34a, as shown in FIG. 11.

Subsequent to the initial pulling of the packet structure 48a through the opening 34a, the knife structure 72 is moved to a tear position which provides for the end of the blade structure 74 to pierce the envelope structure 50a and be displaced through the entire thickness thereof. The movement of the knife structure 72 from the neutral position to the tear position is provided by the container structure 22a and tab structure 80 being grasped by the other hand of the user. More specifically, the tab structure 80 and container structure 22a may be grasped by the thumb of the other hand of the user contacting the outer surface 81 of the tab structure 80 and the fingers of this hand of the user contacting the outer surface 31a of the bottom structure 28a. The thumb and fingers which contact the tab structure 80 and outer surface 31a are forced together which moves the knife 22 to the tear position.

The grip of the thumb of the user against the outer surface 81 of the tab structure 80 is facilitated by the recesses 86 which provide the outer surface 81 with an uneven contour. Consequently, slipping of the thumb relative to the outer surface 81 is resisted. Also, the recesses 86 provide a visual indication of the tab structure 80 to facilitate location thereof by the user.

Subsequent to the movement of the knife structure 72 to the tear position, the pulling of the packet structure 48a from the cavity 32a through the opening 34a is resumed. The packet structure 48a is pulled through the opening 34a with sufficient force such that the contact of the envelope structure 50a against the cutting edge 78 of the blade structure 74 which extends through the envelope structure provides for the tearing thereof, as shown in FIG. 11. The tearing of the envelope structure 50a is facilitated by the orientation of the blade structure 74 which provides for the cutting edge 78 to face the packet structure 48a. Consequently, the packet structure 48a initially contacts the cutting edge 78 when the packet structure is pulled from within the cavity 32a through the opening 34a.

The tab structure 80 is held in the tear position continuously throughout the pulling of the packet structure 48a from within the cavity 32a through the opening 34a. The pulling is sufficient for the complete removal of the packet structure 48a from the cavity 32a. Consequently, the tear in the envelope structure 50a which is provided by the knife structure 72 extends continuously to the side edge 54a, as shown in FIG. 11.

Subsequent to the complete removal of the packet structure 48a from the cavity 32a through the opening 34a, the thumb of the hand of the user is removed from the outer surface 81 of the tab structure 80. Consequently, the knife structure 72 is released from the tear position and returned to the neutral position. The knife structure 72 is returned to the neutral position by the hinge structure 84, the resiliency of which forcibly directs the knife structure 72 from the tear position to the neutral position.

The tearing of the envelope structure 50a provides for the formation of an end structure 88 of the envelope structure, as shown in FIG. 11. The end structure 88 and envelope structure 50a have corresponding interior edges 90, 92 which intersect one another at an interior junction between the end structure and envelope structure.

The end structure 88 is grasped by one of the hands of the users, such as between the thumb and fingers thereof. The envelope structure 50a is grasped by the other hand of the user, such as between the thumb and fingers thereof. The hands of the user and the respective end structure 88 and envelope structure 50a which are grasped therein are displaced relative to one another to displace the end structure relative to the envelope structure. The relative displacement of the end structure 88 and envelope structure 50a provides further tearing thereof for access to the cavity in the envelope structure.

After the completion of the tearing of the envelope structure 50a by the displacement of the end structure 88 relative to the envelope structure 50a, access to the strip structure in the cavity in the envelope structure is obtained, such as by separating transversely the opposing surfaces thereof. Subsequently, the strip structure is removed from the cavity in the envelope structure 50a.

An alternative embodiment of the method for operating the packet dispenser 20a is possible in which the knife structure 72a is moved from the neutral position to the tear position before the initiation of the pulling of the packet structure 48a from within the cavity 32a through the opening 34a. Consequently, the blade structure 74a is initially contacted by the side edge 53a of the envelope structure 50a. The packet structure 48a is pulled through the opening 34a with sufficient force such that the envelope structure 50a is torn by the blade structure 74. The knife structure 72 is held in the tear position continuously throughout the pulling of the packet structure 48a from the cavity 32a through the opening 34a. Consequently, the envelope structure 50a is torn continuously from the side edge 53a to the side edge 54a. The continuous tearing between the side edges 53a, 54a provides for the complete severing of the end structure 88 from the envelope structure 50a which contains the strip structure. Consequently, the envelope structure 50a does not have an end structure connected thereto, such as the end structure 88, following the complete removal of the packet structure 48a from the cavity 32a through the opening 34a. This makes unnecessary further tearing of the envelope structure 50a, such as the manual tearing of the end structure 88, to gain access to the strip structure in the cavity in the envelope structure 50a.

While the invention has been described by reference to certain preferred embodiments, it should be understood that numerous changes could be made within the spirit and scope of the inventive concept described. Accordingly, it is intended that the invention not be limited to the disclosed embodiments, but that it have the full scope permitted by the language of the following claims.

1-20. (canceled)

21. A packet dispenser comprising:
more than one packet structure, wherein each of said packet structures comprises an envelope having a cavity and a strip structure contained therein;
a container structure having an interior cavity, said interior cavity having a sufficient dimension such that said packet structure may be stored therein;
said container structure having an opening to said interior cavity through which said packet structure can be removed there from; and
a tear structure connected to said container structure such that each of said packet structures may contact said tear structure to tear a portion thereof when each of said packet structures is removed from said cavity.

22. A packet dispenser according to claim 21, wherein said container structure has an inner surface which defines said cavity, said tear structure comprising a knife structure connected to said inner surface.

23. A packet dispenser according to claim 22, wherein said opening is elongate and has a first end and a second end, said knife structure being located relative to said opening such that said knife structure is closer to said first end relative to said second end.

24. A packet dispenser according to claim 22, wherein said knife structure is connected to said inner surface such that said knife structure can be moved from a neutral position to a tear position, the packet structure contacting said knife structure when said knife structure is in said tear position and the packet structure is pulled through the opening, said knife structure being located relative to the packet structure when said knife structure is in said neutral position such that a clearance is provided between said knife structure and the packet structure.

25. A packet dispenser according to claim 22, wherein said knife structure is connected to said inner surface such that said knife structure is forcibly directed by a portion thereof or by said container surface to said neutral position when said knife structure is in said tear position.

26. A packet dispenser according to claim 22, wherein said knife structure comprises an elongate blade structure having a base which is connected to said inner surface, said blade structure having a cutting edge which extends from said base, said blade structure being oriented relative to said inner surface such that said cutting edge contacts the packet structure for tearing thereof when the packet structure is removed from said cavity.
